(19) United States
(12) Patent Application Publication
(10) Pub. No.: US 2005/0036245 A1
(43) Pub. Date: Feb. 17, 2005

(54) Bridge power converter overload protection

(75) Inventor: Fred F. Greenfeld, Satellite Beach, FL (US)

Correspondence Address: LAW OFFICES OF GARY R. STANFORD, 330 W OVERLOOK MOUNTAIN RD, BUDA, TX, 78610, US

(73) Assignee: Intersil Americas Inc., Milpitas, CA (US)

(21) Appl. No.: 10/641,505

(22) Filed: Aug. 15, 2003

(51) Int. Cl. H02H 3/08

(52) U.S. Cl. 361/18

(57) ABSTRACT

A DC-DC power converter including a bridge converter, a switching controller, a current sensing device, a current amplifier, and a PWM generator. The switching controller controls switching of the bridge converter based on a PWM signal. The current sensing device provides an average current signal indicative of an average output current of the bridge converter. The current amplifier compares the average current signal with a current reference signal and outputs an overload signal indicative thereof. The PWM generator generates the PWM signal and modifies the duty cycle of the PWM signal when the overload signal indicates an overload condition. The bridge converter may be implemented as either a half-bridge or a full-bridge converter. The current is sensed at the output or at the transformer primary. The sensed current may be processed to provide a signal proportional to average output current.

### CROSS-REFERENCE TO RELATED APPLICATIONS

### BACKGROUND OF THE INVENTION

1. Field of the Invention

The present invention relates to power converters, and more particularly to an overload protection system and method based on average current that enables a bridge converter to continue operation during overload conditions.

2. Description of the Related Art

A DC-DC power supply, otherwise known as a bridge converter, is usually provided with a means of overload protection when the output is overloaded. An overload condition occurs when the output current exceeds a predetermined limit. Bridge converters, including half-bridge and full bridge converters, typically include a peak current monitoring function that enables a protection function when the peak current exceeds a predetermined value. When such converters are operated by a control method known as voltage mode control and when they use pulse-by-pulse peak current limit, their behavior becomes unstable when operated in an overload condition for more than a few switching cycles. The activation of the overload circuitry based on pulse-by-pulse peak current defeats the function of DC blocking capacitors, thereby causing the bridge to become unbalanced.

The DC blocking capacitors are provided to balance the volt-seconds applied to the isolation transformer to prevent core saturation. The peak current control function terminates the half cycle based on peak current, which causes the DC blocking capacitors to develop a charge that is not based on volt-second imbalance thereby resulting in a mismatch of volt-seconds on the transformer core. The duty cycle applied to the transformer core becomes asymmetric between the two half cycles of a switching period, resulting in intrinsically unstable operation. The normal methodology is to disable or otherwise shutdown the converter in the event of an overload condition.

One particular subclass of converters is known as bus regulators or DC transformers in which the outputs are unregulated. A primary characteristic of these converters is that there is no closed loop feedback control for output regulation. These converters operate at nearly 100% duty cycle and act as an efficient means to step voltage up or down. The output inductors of such converters are very small relative to their counterparts in a regulated converter because of the high duty cycle and low voltage applied across them. The amplitude of ripple current is very low resulting in a small difference between the average current and the peak current. Using peak current limit forces the overload setpoint to be close to the maximum average output current. When an overload condition occurs, the peak current limit begins to terminate the duty cycle earlier in the switching cycle. As the current is further increased, the duty cycle terminates earlier and earlier. As the duty cycle is reduced, the output voltage, being proportional to the duty cycle, decreases, which causes the voltage applied across the output inductor to increase. The ripple current in the output inductor also increases proportionately. Since the peak current limit setpoint remains the same, the average current must decrease. The result is that the average output current is reduced below the normal steady state operating current. If the current level is reduced to the level prior to the overload condition, the converter will not recover. The current limit could be set much higher than the rated level, but this would require that the converter be over-designed for the application, which defeats the benefits of using such converters in the first place.

It is desired to allow a bridge converter to continue to operate during an overload condition without shutting it down or causing it to become unstable.

### SUMMARY OF THE INVENTION

An overload protection circuit for a power converter according to an embodiment of the present invention includes a current sensor, a current comparator, and a control circuit. The current sensor circuit determines an average current signal based on a current level of the power converter. The average current signal may be based on average current, peak switching current, or other representation of output current. The current comparator compares the average current signal with a current reference signal and provides a current control signal indicative thereof. The control circuit controls switching of the power converter based on the current control signal during an overload condition.

In various configurations, the current may be sensed at the output of the power converter or at the transformer primary. The control circuit may include a PWM comparator that provides a PWM signal having a duty cycle indicative of the current control signal during the overload condition. The power converter may be implemented as an open loop configuration or with voltage mode control. A peak current detector may also be included for faster response.

A DC-DC power converter according to an embodiment of the present invention includes a bridge converter, a switching controller, a current sensing device, a current amplifier, and a PWM generator. The switching controller controls switching of the bridge converter based on a PWM signal. The current sensing device provides a current signal indicative of an average output current of the bridge converter. The current amplifier amplifies the difference between the current signal and a current reference signal and outputs a time averaged overload signal indicative thereof. The PWM generator generates the PWM signal and modifies the duty cycle of the PWM signal when the overload signal indicates an overload condition. The bridge converter may be implemented as either a half-bridge or a full-bridge converter.

A method of operating a bridge converter controlled by a PWM signal according to an embodiment of the present invention includes comparing average output current of the bridge converter with a current reference and generating an overload signal indicative thereof, and modifying the duty cycle of the PWM signal based on the overload signal. The method may include detecting a primary current of the bridge converter, converting the primary current to a current signal indicative of the average output current, and comparing the representative current signal with a current reference signal for controlling the PWM signal. The signal for controlling the PWM signal is the result of time averaging over one or more switching cycles a signal representative of the difference between the output current and the desired current limit reference. The method may further include generating a peak control signal indicative of the output exceeding a peak current level.

### BRIEF DESCRIPTION OF THE DRAWINGS

The benefits, features, and advantages of the present invention will become better understood with regard to the following description, and accompanying drawings where:

FIG. 1 is a simplified block diagram of an exemplary voltage mode controlled power converter implemented according to an embodiment of the present invention;

FIGS. 2A and 2B are simplified schematic diagrams of exemplary half-bridge and full-bridge converters, respectively, which may be used as the bridge converter of FIG. 1;

FIG. 3 is a timing diagram illustrating operation of the power converter of FIG. 1 using either the half-bridge converter of FIG. 2A or the full-bridge converter of FIG. 2B;

FIG. 4 is a simplified block diagram of another exemplary voltage mode controlled power converter implemented according to an embodiment of the present invention;

FIG. 5 is a simplified block diagram of an exemplary open loop power converter implemented according to an embodiment of the present invention; and

FIG. 6 is a more detailed schematic diagram of an unregulated power converter implemented according to an embodiment of the present invention.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

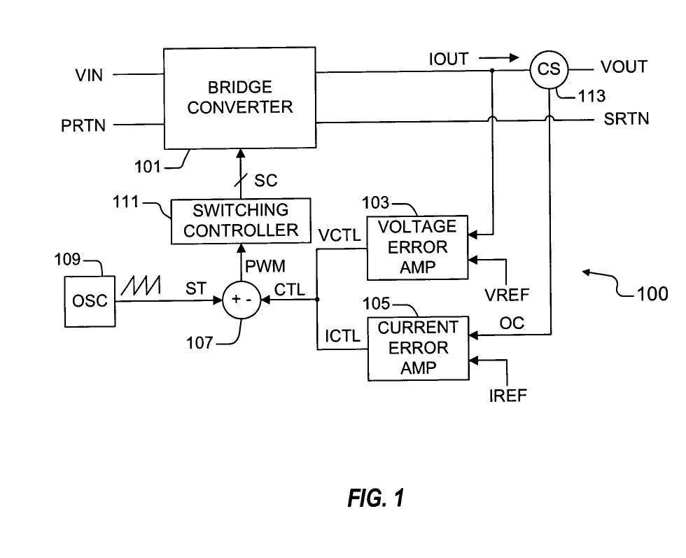

The inventor of the present application has recognized the need for protecting a pulse-width modulation (PWM) bridge power converter operated using pulse-by-pulse current limit during overload condition without shutting down the converter and without causing the converter to become unstable. He has therefore developed an average current overload protection circuit that allows the converter to continue operation during overload conditions without interfering with the function of DC blocking capacitors, as will be further described below with respect to FIGS. 1-6.

FIG. 1 is a simplified block diagram of an exemplary voltage mode controlled power converter 100 implemented according to an embodiment of the present invention. An input voltage signal VIN is provided to a bridge converter 101 relative to a primary return signal PRTN. The bridge converter 101 is implemented according to any standard bridge converter as known to those skilled in the art, such as a half-bridge or a full-bridge converter. The bridge converter 101 generates an output voltage (VOUT) signal relative to a secondary return signal SRTN. A voltage error amplifier 103 measures the voltage level of the VOUT signal and outputs a voltage control signal VCTL, which is proportional to the difference between the VOUT signal and an output voltage reference signal VREF. The output of the voltage error amplifier 103 is summed or otherwise connected to the output of a current error amplifier 105 in such a manner so as to allow the amplifier having the lowest output signal to dominate. As shown, the current error amplifier 105 asserts a current control signal ICTL summed together or otherwise connected with the VCTL signal to collectively provide a control signal CTL.

The CTL signal is provided to a negative or inverting input (−) of a PWM comparator 107, which receives a sawtooth signal ST at its positive or non-inverting input (+). The ST signal is generated by a sawtooth oscillator circuit 109. The comparator 107 compares the CTL signal with the ST signal and generates a corresponding pulse-width modulation signal PWM at its output as known to those skilled in the art. A switching controller 111 receives the PWM signal and generates multiple switching control signals SC provided to control the switching of the bridge converter 101.

A current sensor 113 senses the output current IOUT of the bridge converter 101 and generates an output current signal OC proportional to IOUT. The current sensing device 113 may be implemented using any suitable current sensing device as known to those skilled in the art, such as a current transducer, a current sensing transformer, etc. The OC signal is provided to an input of the current error amplifier 105, which outputs the ICTL signal having a voltage level proportional to the difference between the average output current of the bridge converter 101 and the voltage level of an output current reference signal IREF. The IREF signal has a voltage level selected to correspond with the maximum desired steady state output current of the bridge converter 101. In one embodiment, the current sensor 113 generates the OC signal proportional to the average of the IOUT signal. Alternatively, the current error amplifier 105 determines the average output current based on the OC signal for purposes of comparison with the IREF signal.

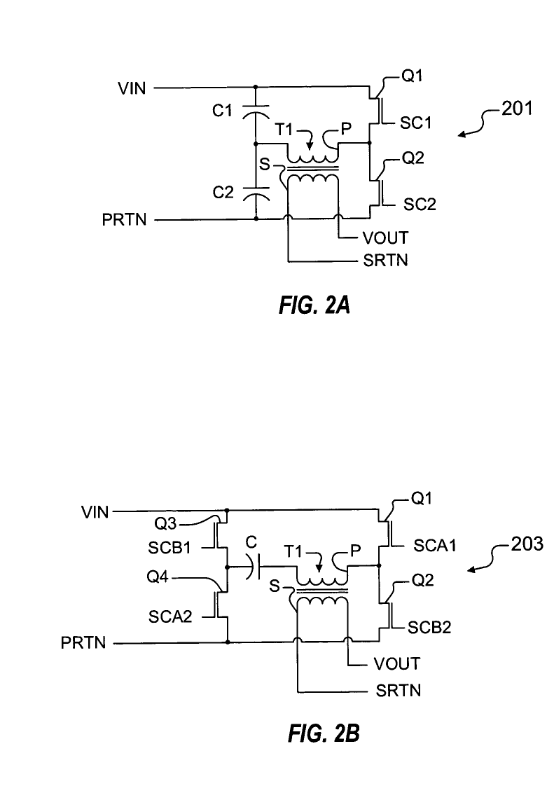

FIG. 2A is a simplified schematic diagram of an exemplary half-bridge converter 201 which may be used as the bridge converter 101. The VIN signal is provided to one end of a DC capacitor C1 and to a first current terminal (e.g., drain or source) of a switch Q1. The switches are designated with Q reference numbers and schematically shown as simplified representations of field-effect transistors (FETs), where it is understood that any or all of the switches may be implemented with suitable alternative switching devices, such as N-channel devices, P-channel devices, metal-oxide semiconductor FETs (MOSFETs), bipolar-junction transistors (BJTs), insulated gate bipolar transistors (IGBTS), etc. The second current terminal of the switch Q1 is coupled to a first current terminal of a second switch Q2 and to one end of a primary winding P of a transformer T1. The other end of the capacitor C1 is coupled to the other end of the primary winding P and to one end of another capacitor C2. The other end of the capacitor C2 and the second current terminal of the switch Q2 are coupled together to develop the PRTN signal. The VOUT and SRTN signals are developed at the opposite ends of the secondary winding S of the transformer T1.

The multiple switching control signals SC include a first switching signal SC1 provided to the gate of the switch Q1 and a second switching signal SC2 provided to the gate of the switch Q2. The switching controller 111 activates the switch Q1 during one cycle of the PWM signal and activates the switch Q2 during the next cycle of the PWM signal and operation continuously alternates in this manner as known to those skilled in the art.

FIG. 2B is a simplified schematic diagram of an exemplary full-bridge converter 203 which may be used as the bridge converter 101. The full-bridge converter 203 is similar to the half-bridge converter 201 where similar components assume identical reference numbers. The transformer T1 and the switches Q1 and Q2 are included and coupled in a similar manner between the VIN and PRTN signals and to one end of the primary winding P of the transformer T1. The other end of the primary winding P is coupled to one end of a single DC capacitor C. The full-bridge converter 300 includes another pair of switches Q3 and Q4, where the VIN signal is provided to a first current terminal of switch Q3, having a second terminal coupled to a first current terminal of the switch Q4 and to the other end of the capacitor C. The second current terminal of the switch Q4 is coupled to the PRTN signal.

In this case, the multiple switching control signals SC include first and second switching signals SCA1 and SCA2 provided to the gates of the switches Q1 and Q4, respectively, and third and fourth switching signals SCB1 and SCB2 provided to the gates of the switches Q3 and Q2, respectively. The switching controller 111 activates the switches Q1 and Q4 during one cycle of the PWM signal and activates the switches Q2 and Q3 during the next cycle of the PWM signal and operation continuously alternates in this manner as known to those skilled in the art.

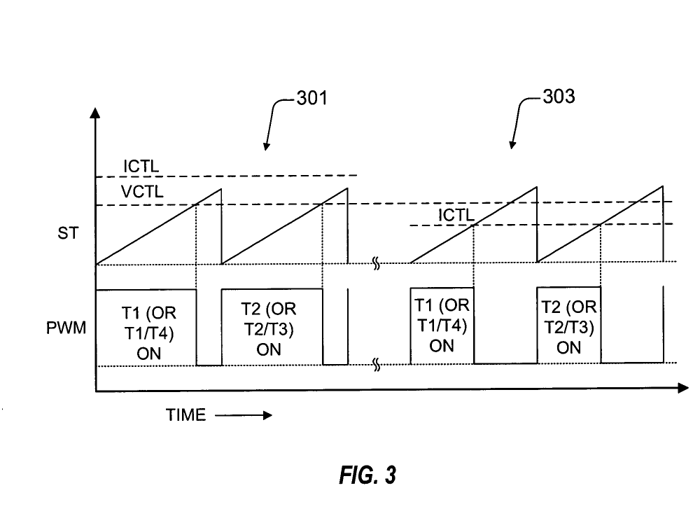

FIG. 3 is a timing diagram illustrating operation of the power converter 100 using either the half-bridge converter 201 or the full-bridge converter 203. The ST, ICTL, VCTL and PWM signals are plotted versus time for normal operating conditions shown at 301 and during an overload condition shown at 303. The signals are not necessarily shown to scale. For example, the duty cycle of the PWM signal is shown to emphasize the difference between the normal operating conditions shown at 301 as compared to the overload conditions shown at 303. In general, during a first cycle and every other cycle thereafter of the PWM signal, the switching controller 111 turns on the switch Q1 (or the switches Q1 and Q4) and turns off the switch Q2 (or the switches Q2 and Q3). During the second cycle and every other cycle thereafter of the PWM signal, the switching controller 111 turns on the switch Q2 (or the switches Q2 and Q3) and turns off the switch Q1 (or the switches Q1 and Q4). For each PWM cycle, the switching controller 111 keeps the activated switches on until the PWM signal goes low, at which time all switches are turned off during the remainder of that cycle. The comparator 107 pulls the PWM signal high at the beginning of each cycle and keeps it high until the ST signal exceeds the CTL signal, so that the level of the CTL signal controls the duty cycle of the PWM signal. The lesser of the VCTL and ICTL signals determines the level of the CTL signal.

Under normal operating conditions when the power converter 100 is not experiencing an overload condition as shown at 301, the voltage error amplifier 103 dominates since the VCTL signal is lower than the ICTL signal. Thus, the VCTL signal determines the level of the CTL signal which controls the duty cycle of the PWM signal to control the output voltage of the VOUT signal. When an overload condition occurs as shown at 303, the current error amplifier 105 lowers the ICTL signal below the VCTL signal so that the ICTL signal controls the duty cycle of the PWM signal. In particular, the duty cycle of the PWM signal is reduced during the overload condition to maintain an essentially constant output current and symmetric duty cycle determined by the IREF signal.

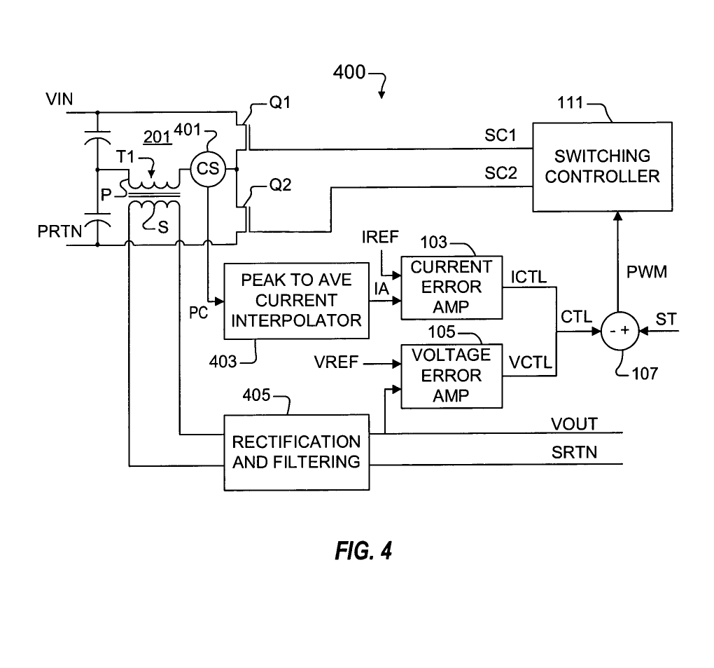

FIG. 4 is a simplified block diagram of another exemplary voltage mode controlled power converter 400 implemented according to an embodiment of the present invention. The power converter 400 is similar to the power converter 100 where similar components assume identical reference numbers. The half-bridge converter 201 replaces the bridge converter 101, and a current sensor 401 is coupled to the primary winding P of the transformer T1 for sensing peak current. The current sensor 401 outputs a primary current signal PC to a peak to average current interpolator 403. The peak to average current interpolator 403 generates a signal indicative of the average output current from the PC signal and outputs an average current signal IA to the current error amplifier 103. The current error amplifier 103 also receives the IREF signal and operates in a similar manner as previously described to generate the ICTL signal. The terminals of the secondary winding S are provided to a rectification and filtering circuit 405, which develops the VOUT signal relative to the SRTN signal. The voltage error amplifier 105 is also included and receives the VREF and VOUT signals for developing the VCTL signal as previously described. Also, the ICTL and VCTL signals are connected, summed or otherwise combined to provide the CTL signal provided to the comparator 107 for developing the PWM signal, which is provided to the switching controller 111. The switching controller 111 generates the SC1 and SC2 signals as previously described, which are provided to the gates of the switches Q1 and Q2 of the half-bridge converter 201.

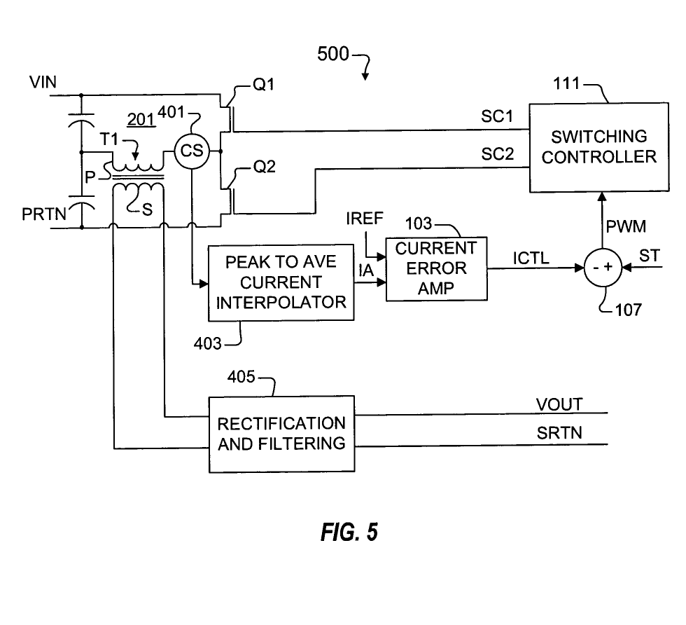

FIG. 5 is a simplified block diagram of an exemplary open loop power converter 500 implemented according to an embodiment of the present invention. The power converter 500 is similar to the power converter 400 in which similar components assume identical reference numbers. In this case, the voltage feedback control loop using the voltage error amplifier 105 is eliminated and only the current loop remains. Thus, the ICTL signal is provided directly to the comparator 107. During normal operation of the open loop power converter 500, the ICTL signal exceeds the level of the ST signal for the entire switching cycle so that maximum duty cycle is achieved. When an overload condition occurs, the current error amplifier 103 reduces the ICTL signal to reduce the duty cycle of the PWM signal in order to maintain a constant output current and maintain flux balance in transformer T1.

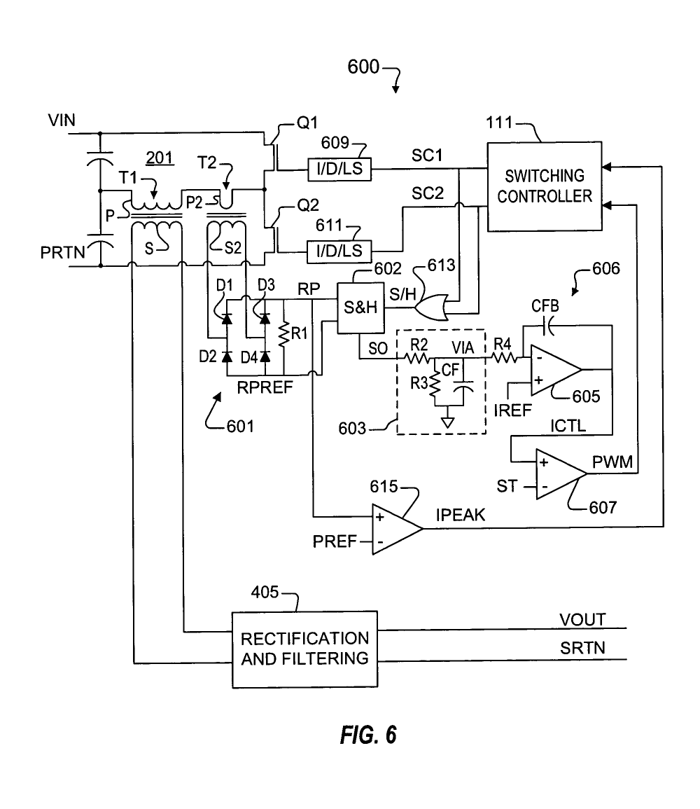

FIG. 6 is a more detailed schematic diagram of an unregulated power converter 600 implemented according to an embodiment of the present invention. The power converter 600 is similar to the power converter 500 where similar components assume identical reference numbers. The half-bridge converter 201 is included with the secondary winding S of the transformer T1 coupled to the rectification and filtering circuit 405, which develops the VOUT signal relative to the SRTN signal as previously described. The current sensor 401 is replaced with a current transducer shown as a current sense transformer T2. The transformer T2 has a primary winding P2 coupled in series with the primary winding P of the transformer T1 for sensing primary current, and a secondary winding S2 coupled to a full-wave rectifier circuit 601 including diodes D1-D4. In particular, one end of the secondary winding S2 is coupled to the anode of diode D1 and to the cathode of diode D2. The other end of the secondary winding S2 is coupled to the anode of diode D3 and to the cathode of diode D4. The cathodes of diodes D1 and D3 are coupled together and develop a rectified primary signal RP provided to a sample and hold (S&H) circuit 602. The anodes of diodes D2 and D4 are coupled together and develop a current peak signal RPREF provided to the S&H circuit 602. A burden resistor R1 is coupled between the RP and RPREF signals. The RPREF signal may be coupled to ground to reference the RP signal to ground.

The S&H circuit 602 samples the RP signal and generates an output sample signal SO, which is provided to a resistor/capacitor (R/C) amplitude and bandwidth compensation filter circuit 603. In particular, the SO signal is provided to one end of a resistor R2, having its other end coupled to one end of a resistor R3 and to one end of a capacitor CF for developing a voltage proportional to average output current signal VIA. The other ends of the resistor R3 and the capacitor CF are coupled to ground. The VIA signal is provided to one end of a resistor R4, having its other end coupled to the inverting input of an amplifier (e.g., an op amp, comparator, etc.) 605 and to one end of a feedback capacitor CFB. The other end of the capacitor CFB is coupled to the output of the amplifier 605, which develops the current control signal ICTL. The IREF signal is provided to the non-inverting input of the amplifier 605. The resistor R4, the capacitor CFB and the amplifier 605 form a current amplifier 606, which compares the VIA and IREF signals for developing the ICTL signal in a similar manner as previously described.

The ICTL signal is provided to the non-inverting input of another amplifier 607, which receives the sawtooth signal ST at its inverting input. The amplifier 607 serves as the PWM generator for developing the PWM signal, which is provided to the switching controller 111. The switching controller 111 develops the SC1 and SC2 signals, which are each provided to respective isolation/driver/level shifter (I/D/LS) circuits 609 and 611, which drive the switches Q1 and Q2, respectively, of the half-bridge converter 201. The SC1 and SC2 signals are also provided to respective inputs of a 2-input OR gate 613, which generates a sample/hold signal S/H provided to the S&H circuit 611. The RP signal is provided to the non-inverting input of another amplifier 615, which receives a peak reference voltage signal PREF at its inverting input. The output of the amplifier 615 asserts a peak current limit signal IPEAK, which is provided to the switching controller 111.

The current sense transformer T2, the rectifier full-wave rectifier 601 and the burden resistor R1 are used to translate and scale the primary current of the transformer T1 into the RP signal, which is a low voltage ground-referenced signal. The RP signal is used by both the S&H circuit 602 and the peak current limit detector amplifier 615. The peak current limit detector amplifier 615 operates similar to peak limit control circuits known to those skilled in the art and is not further described. The switching controller 111 controls the switching of the switches Q1 and Q2 via the SC1 and SC2 signals as previously described. The S&H circuit 602 captures the voltage representation of the primary current of the transformer T1 when either of the main switches Q1 or Q2 are on (via operation of the OR gate 613) and holds the captured voltage at its output SO. In other embodiments, the S&H circuit 602 may capture the signal at anytime during the on time, or may sample multiple times, to construct a representation of the current amplitude. The SO signal is scaled and bandwidth limited by the filter circuit 603, which outputs the VIA voltage signal representing the average output current. The current amplifier 606 amplifies the difference between the output current signal and the IREF reference voltage signal, which corresponds to the desired average current limit, and generates the ICTL signal used to control the duty cycle of the PWM signal during an overload condition.

During normal operation when the average current signal VIA is less than IREF, the ICTL signal asserted by the current amplifier 606 is at a maximum and the PWM signal is generated with maximum duty cycle. If the output current increases and causes an overload condition, the VIA signal is increased above the IREF signal and the ICTL signal is correspondingly reduced by the current amplifier 606. The reduction of the ICTL signal reduces the duty cycle of the PWM signal so that the output current does not exceed the target current level determined by the IREF signal.

It is appreciated by those of ordinary skill in the art, therefore, that average current overload protection circuits according to embodiments of the present invention correct the problem of unstable operation during overload conditions by using average current to control operation during overload conditions. Average current overload protection is used to allow the power converter to continue operating during overload conditions because the protection circuit does not interfere with the function of the DC blocking capacitors (e.g., C1 and/or C2). Average current limit does not result in volt-second imbalance of the transformer core, the converter maintains essentially constant output current during the overload condition, and the converter recovers to normal operation when the overload condition is removed. The present invention helps voltage mode controlled bridge converters by limiting output current to a desired level without causing a volt-second imbalance in the transformer and by allowing continued operation.

The present invention is particularly advantageous for converters in which the outputs are unregulated, such as bus regulators or DC transformers. As previously described, such converters have no closed loop feedback control for output regulation, operate at nearly 100% duty cycle, have relatively small output inductors, and operate with very low amplitude ripple current. The ripple current amplitude has a “D” factor (1-D, where “D”=duty cycle) in its calculation such that the ripple current amplitude is low at very low or very high duty cycle and is a maximum at 50% duty cycle. For example, the ripple current increases by a factor of about 5 when going from 95% to 50% duty cycle. Using average current limit according to embodiments of the present invention, however, allows the available output current to remain essentially constant regardless of duty cycle and output voltage level. Thus, if the overload condition is decreased or removed, the power converter recovers. Although average current limit has a relatively low bandwidth and does not react as quickly as peak current limit, the two methods may be combined to achieve an optimal solution. Such is shown by the unregulated power converter 600 using both average and peak control methods.

Although the present invention has been described in considerable detail with reference to certain preferred versions thereof, other versions and variations are possible and contemplated. Those skilled in the art should appreciate that they can readily use the disclosed conception and specific embodiments as a basis for designing or modifying other structures for providing out the same purposes of the present invention without departing from the spirit and scope of the invention as defined by the appended claims.

1. An overload protection circuit for a power converter, comprising:
a current sensor circuit that determines an average current signal based on a current level of the power converter;
a current comparator, coupled to said current sensor circuit, that compares said average current signal with a current reference signal and that provides a current control signal indicative thereof; and
a control circuit, coupled to said current comparator, that controls switching of the power converter based on said current control signal during an overload condition.

2. The overload protection circuit of claim 1, wherein:
said current sensor circuit comprises a current sensor for coupling to an output of the power converter for providing said average current signal; and
wherein said control circuit comprises a PWM comparator that provides a PWM signal having a duty cycle indicative of said current control signal during said overload condition.

3. The overload protection circuit of claim 2, further comprising:
a voltage comparator that compares an output voltage level of the power converter with a voltage reference signal and that outputs a voltage control signal indicative thereof to said PWM comparator; and
wherein said voltage comparator controls said PWM comparator during normal operation and said current comparator controls said PWM comparator during said overload condition.

4. The overload protection circuit of claim 1, the power converter having a transformer with a primary winding, wherein:
said current sensor circuit comprises:
a current sensor that outputs a primary current signal indicative of current through the primary winding; and
a peak to average current interpolator, coupled to said current sensor, that interpolates said average current signal from said primary current signal; and
wherein said control circuit comprises a PWM comparator that provides a PWM signal having a duty cycle indicative of said current control signal during said overload condition.

5. The overload protection circuit of claim 4, further comprising:
a voltage comparator that compares an output voltage level of the power converter with a voltage reference signal and that outputs a voltage control signal indicative thereof to said PWM comparator; and
wherein said voltage comparator controls said PWM comparator during normal operation and said current comparator controls said PWM comparator during said overload condition.

6. The overload protection circuit of claim 1, the power converter having a transformer with a primary winding, further comprising:
said current sensor circuit comprising:
a current transducer for coupling to the primary winding;
a rectifier circuit coupled to said current transducer;
a sample and hold circuit, coupled to said rectifier circuit, that samples rectified primary current; and
a filter circuit, coupled to said sample and hold circuit, that converts samples of said rectified primary current to said average current signal; and
said control circuit comprising:
a PWM comparator, coupled to said current comparator, that compares a sawtooth signal with said current control signal and that provides PWM a signal indicative thereof; and
a switching controller, coupled to said PWM comparator, that generates transformer switching signals based on said PWM signal.

7. The overload protection circuit of claim 6, further comprising:
a gate receiving said switching signals and providing an activation signal; and
wherein said sample and hold circuit samples said rectified primary current upon assertion of said activation signal.

8. The overload protection circuit of claim 6, wherein said rectifier circuit comprises a full-wave rectifier coupled to a burden resistor.

9. The overload protection circuit of claim 6, further comprising a peak current detector, coupled to said rectifier circuit, that compares said rectified primary current with a peak current reference signal and that provides a peak control signal indicative thereof to said control circuit.

10. A DC-DC power converter, comprising:
a bridge converter;
a switching controller that controls switching of said bridge converter based on a PWM signal;
a current sensing device that provides an average current signal indicative of an average output current of said bridge converter;
a current amplifier, coupled to said current sensing device, that compares said average current signal with a current reference signal and that outputs an overload signal indicative thereof; and
a PWM generator that generates said PWM signal and that modifies the duty cycle of said PWM signal when said overload signal indicates an overload condition.

11. The DC-DC power converter of claim 10, wherein said bridge converter comprises a half-bridge converter.

12. The DC-DC power converter of claim 10, wherein said bridge converter comprises a full-bridge converter.

13. The DC-DC power converter of claim 10, wherein:
said bridge converter includes a transformer with a primary winding; and
wherein said current sensing device comprises:
a current transducer coupled to said primary winding for sensing primary current; and
a peak to average interpolator, coupled to said current transducer, that provides said average current signal.

14. The DC-DC power converter of claim 13, further comprising:
said transformer including a secondary winding;
a rectification and filtering circuit coupled to said secondary winding for providing an output voltage signal;
a voltage amplifier that compares said output voltage signal with a voltage reference signal for providing a voltage error signal; and
said PWM generator generating said PWM signal based on said voltage error signal during normal operation and generating said PWM signal based on said overload signal during said overload condition.

15. The DC-DC power converter of claim 10, wherein:
said bridge converter includes a transformer with a primary winding;
wherein said current sensing device comprises:
a current transducer coupled to said primary winding;
a rectifier circuit coupled to said current transducer;
a sample and hold circuit, coupled to said rectifier circuit, that samples rectified primary current; and
a filter, coupled to said sample and hold circuit, that outputs said average current signal based on primary current samples; and
wherein said PWM generator comprises a PWM comparator, coupled to said current amplifier, that compares a sawtooth signal with said overload signal and that provides said PWM signal indicative thereof.

16. The DC-DC power converter of claim 15, further comprising:
said switching controller generating transformer switching signals based on said PWM signal;
said sample and hold circuit sampling said rectified primary current based on an activation signal; and
a gate receiving said switching signals and providing said activation signal.

17. The overload protection circuit of claim 15, further comprising a peak current detector, coupled to said rectifier circuit, that compares said rectified primary current with a peak current reference signal and that provides a peak current overload signal indicative thereof to said switching controller.

18. A method of operating a bridge converter controlled by a PWM signal, comprising:
comparing average output current of the bridge converter with a current reference and generating an overload signal indicative thereof; and
modifying the duty cycle of the PWM signal based on the overload signal.

19. The method of claim 18, further comprising:
detecting a primary current of the bridge converter;
converting the primary current to an averaged current signal indicative of the average output current; and
said comparing comprising comparing the average current signal with a current reference signal.

20. The method of claim 18, further comprising:
measuring current through a primary winding of a transformer of the bridge converter;
rectifying measured primary current;
sampling rectified primary current;
filtering sampled rectified primary current to provide an averaged current signal indicative of the average output current; and
said comparing comprising comparing the average current signal with a current reference signal.

21. The method of claim 20, further comprising comparing the rectified primary current with a peak current reference signal and generating a peak control signal indicative thereof.
